(19) United States
(12) Patent Application Publication
(10) Pub. No.: US 2026/0336723 A1
(43) Pub. Date: Oct. 29, 2026

(54) VEHICLE TAILGATE HINGE AND WHEEL CARRIER ASSEMBLY

(71) Applicant: FCA US LLC, Auburn Hills, MI (US)

(72) Inventor: David K. Simancik, Auburn Hills, MI (US)

(21) Appl. No.: 19/190,008

(22) Filed: Apr. 25, 2025

(51) Int. Cl. B62D 33/027; B62D 43/02; E05D 3/02

(52) U.S. Cl. CPC B62D 33/027; B62D 43/02; E05D 3/02

(57) ABSTRACT

A mount for a tailgate and a wheel may include a first hinge, a second hinge spaced from the first hinge, and a bracket that has an arm. The first hinge, second hinge and bracket may have a common axis of rotation and the bracket may support vehicle accessories such as a tire mount for a spare wheel and tire of the vehicle.

### FIELD

The present disclosure relates to a vehicle tailgate hinge, vehicle tailgate, and wheel carrier assembly.

### BACKGROUND

Some vehicles may have a wheel and tire mounted to a rear tailgate. Some wheels and tires may be larger and heavier, and supporting a larger and heavier wheel and tire on the tailgate while enabling full use of the liftgate presents challenges.

### SUMMARY

In at least some implementations, a mount for a tailgate and a wheel includes a first hinge having a first door leaf adapted to be connected to a vehicle tailgate, a first mount leaf adapted to be connected to a vehicle, a first knuckle defined by both the first door leaf and the first mount leaf, and a first hinge pin, wherein the first knuckle includes a first hinge passage and the first hinge pin is received in the first hinge passage, the first hinge pin defines an axis of rotation of the first door leaf relative to the first mount leaf. A second hinge is spaced from the first hinge, the second hinge having a second door leaf adapted to be connected to the same vehicle tailgate as the first door leaf, a second mount leaf adapted to be connected to the vehicle, a second knuckle defined in part by both the second door leaf and the second mount leaf, and a second hinge pin, wherein the second knuckle includes a second hinge passage and the second hinge pin is received in the second hinge passage. The second hinge pin defines an axis of rotation of the second door leaf relative to the second mount leaf, and the second hinge pin is coaxial with the first hinge pin and axially spaced from the first hinge pin. A bracket that has an arm has a first pair of spaced apart fingers and a second pair of spaced apart fingers extending from the arm. The arm defines at least part of a tire mount adapted to receive a tire, and the first pair of spaced apart fingers define part of a first bracket passage in which the first hinge pin is received and the second pair of spaced apart fingers define part of a second bracket passage in which the second hinge pin is received so that the bracket is connected to the first hinge and the second hinge, and the first hinge pin and the second hinge pin define an axis of rotation of the bracket.

In at least some implementations, the first mount leaf and the second mount leaf are connected by a cross-member.

In at least some implementations, the first mount leaf at least partially axially overlaps the first door leaf at the first knuckle, relative to the axis of rotation.

In at least some implementations, the second mount leaf at least partially axially overlaps the second door leaf at the second knuckle, relative to the axis of rotation.

In at least some implementations, the first mount leaf at least partially radially overlaps the first door leaf at the first knuckle relative to the axis of rotation.

In at least some implementations, the second mount leaf at least partially radially overlaps the second door leaf at the second knuckle relative to the axis of rotation.

In at least some implementations, a vehicle includes a frame, a tailgate, a first hinge having a first door leaf connected to the tailgate, a first mount leaf connected to the frame, a first knuckle defined in part by both the first door leaf and the first mount leaf, and a first hinge pin. The first knuckle includes a first hinge passage and the first hinge pin is received in the first hinge passage. The first hinge pin defines an axis of rotation of the first door leaf relative to the first mount leaf. A second hinge is spaced from the first hinge. The second hinge having a second door leaf connected to the tailgate, a second mount leaf connected to the frame, a second knuckle defined in part by both the second door leaf and the second mount leaf, and a second hinge pin. The second knuckle includes a second hinge passage and the second hinge pin is received in the second hinge passage. The second hinge pin defines an axis of rotation of the second door leaf relative to the second mount leaf, and the second hinge pin is axially aligned with the first hinge pin and axially spaced from the first hinge pin. A bracket has an arm with a first pair of spaced apart fingers and a second pair of spaced apart fingers extending from the arm, the arm defines at least part of a tire mount adapted to receive a tire, and the first pair of spaced apart fingers define part of a first bracket passage in which the first hinge pin is received and the second pair of spaced apart fingers define part of a second bracket passage in which the second hinge pin is received so that the bracket is connected to the first hinge and the second hinge, and the first hinge pin and the second hinge pin define an axis of rotation of the bracket.

In at least some implementations, the tailgate has an inner panel and an outer panel, the inner panel and the outer panel each have inner surfaces that define an interior of the tailgate, and the inner panel and the outer panel each have outer surfaces that define an exterior of the tailgate, and the first door leaf and the second door leaf are located on the exterior of the tailgate.

In at least some implementations, the first door leaf and the second door leaf are coupled to the support structure of the tailgate.

In at least some implementations, the tailgate has an inner panel and an outer panel, the inner panel and the outer panel each have inner surfaces that define an interior of the tailgate and the inner panel and the outer panel each have outer surfaces that define an exterior of the tailgate, and the first door leaf and the second door leaf are coupled to the tailgate and a structural member within the interior of the tailgate.

In at least some implementations, the bracket is fixed to the outer panel so that the bracket and the tailgate move together about the axis of rotation.

In at least some implementations, a structural member is within the interior of the tailgate, wherein the first door leaf and the second door leaf are coupled to the structural member.

In at least some implementations, the structural member is contiguous with the inner surface of the outer panel.

In at least some implementations, the interior of the tailgate is configured to at least partially enclose a window between the inner surfaces of the inner panel and the outer panel.

In at least some implementations, the bracket supports the wheel mount and a wheel of the vehicle.

In at least some implementations, a first pair of the two pairs of fingers are received axially outboard of the first knuckle.

In at least some implementations, one finger of the first pair is received on a first side of the first knuckle and another finger of the first pair is received on a second side of the first knuckle.

In at least some implementations, a second pair of the two pairs of fingers are received axially outboard of the second knuckle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a rear portion of a vehicle;

FIG. 2 is a tailgate of the vehicle of FIG. 1 with a hinge assembly and wheel carrier;

FIG. 3 is a view of an interior of the tailgate of FIG. 2;

FIG. 4 is a perspective view of the hinge assembly of FIG. 2;

FIG. 5 is another perspective view of the hinge assembly of FIG. 2;

FIG. 6 is a cross-section view along section line 6-6 of FIG. 4;

FIG. 7 is a perspective view of the rear portion of the vehicle of FIG. 1 with the tailgate in an open position; and

FIG. 8 is cross-section view along section line 8-8 of FIG. 2.

### DETAILED DESCRIPTION

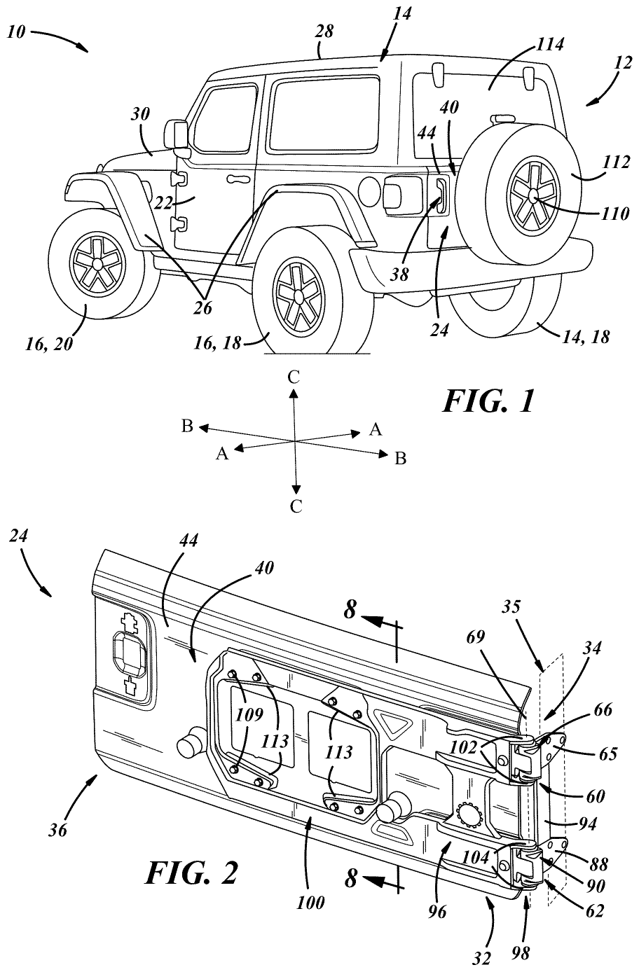

Referring in more detail to the drawings, FIG. 1 illustrates a rear portion 12 of a vehicle 10 having a frame (e.g. a support structure for components of the vehicle), a body 14, and a plurality of wheels 16 coupled to the frame by various suspension components as is known. The plurality of wheels 16 includes two rear wheels 18 that are spaced apart laterally, in what is sometimes called a cross-car direction, extending between driver and passenger (or left and right) sides of the vehicle 10, and as shown by arrow AA. The plurality of wheels 16 also includes two front wheels 20 that are laterally spaced apart from each other and longitudinally spaced from the rear wheels 18, in a fore-aft direction extending between a front and a rear of the vehicle 10, as shown by arrow BB. The body 14 is suspended from a ground surface by the wheels 16, the suspension system, and the frame in a vertical direction shown by arrow CC, which is parallel to the direction of gravity when the vehicle 10 is on a flat, level surface oriented perpendicular to gravity.

As shown in FIG. 1, the vehicle body 14 is defined at least in part by multiple body panels, such as one or more doors 22 at the driver and passenger sides of the vehicle 10, a rear-door or tailgate 24 at the rear of the vehicle 10, fenders 26, a roof 28, and a hood 30. The tailgate 24 may provide access to a passenger compartment and/or a cargo compartment within the interior of the vehicle 10 at the rear of the vehicle 10.

As shown in FIG. 2, at a first end 32, the tailgate 24 is pivotably connected by a hinge assembly 34 to a structural member 35 of the vehicle frame (shown diagrammatically by a dashed line polygon), and the tailgate 24 extends from the first end 32 to a second, free end 36 in the cross-car direction. At or near the free end, a door latch mechanism 38 (FIG. 1) may be configured to releasably couple to a latch located on the vehicle body 14 to enable the tailgate 24 to be held securely in a closed position, and to be selectively unlatched so the tailgate 24 can be pivoted relative to the vehicle body 14.

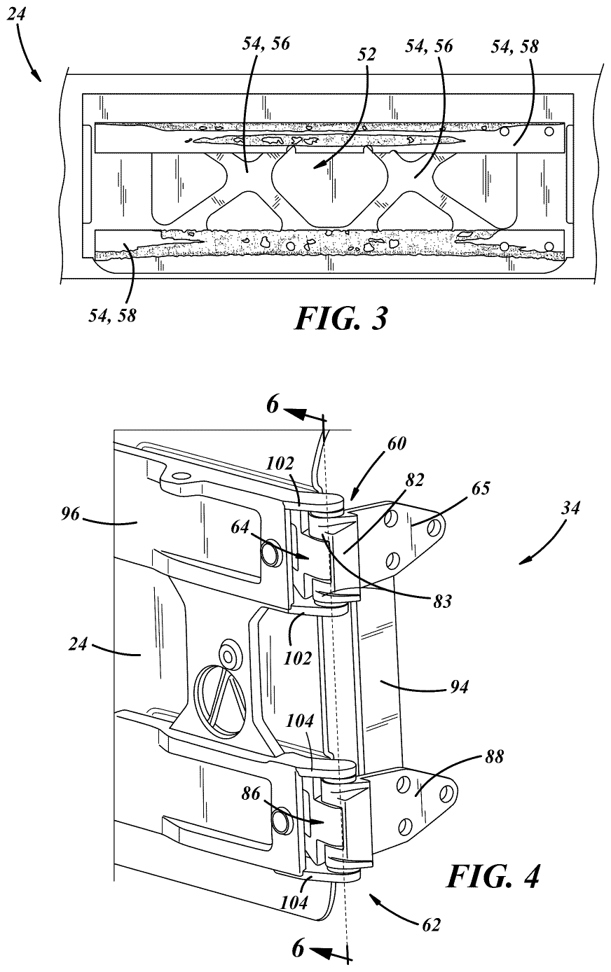

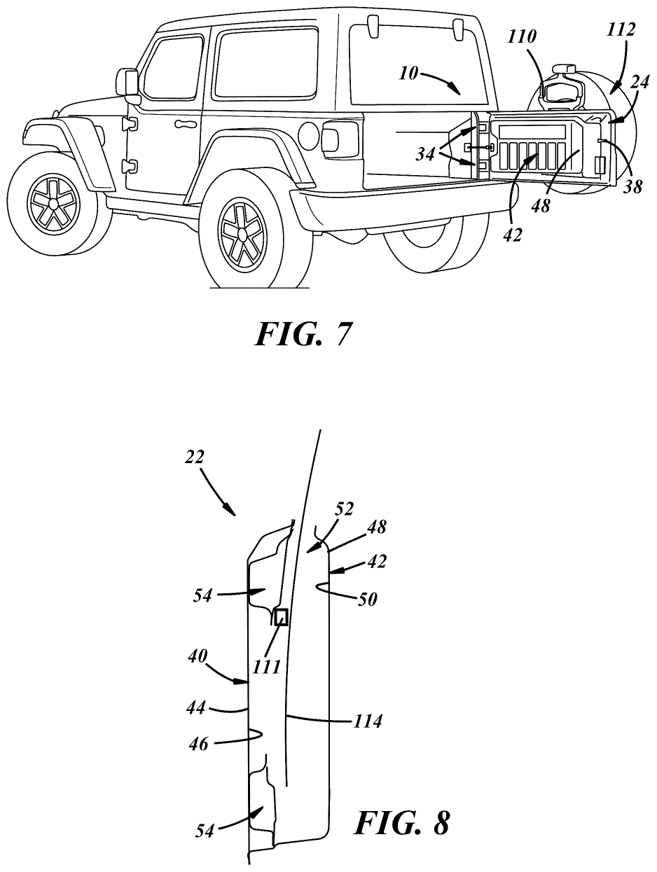

As shown by FIG. 2, the tailgate 24 may have an outer panel 40 that defines part of the exterior of the vehicle 10 and extends the length of the tailgate 24 in the cross-car direction, and vertically at least part of the vertical extent of the tailgate 24. An inner panel 42, shown in FIGS. 7 and 8, is spaced from the outer panel 40 in the fore-aft direction, towards the front of the vehicle 10, and may generally be the same size as the outer panel 40, in at least some implementations. The outer panel 40 has an outer surface 44 that partially defines the exterior of the vehicle 10 and an opposite inner surface 46. The inner panel 42 has an outer surface 48 that may define part of the interior of the vehicle 10, and an inner surface 50 opposite the outer surface 48 and facing toward the inner surface 46 of the outer panel 40. The inner surface 46 of the outer panel 40 and the inner surface 50 of the inner panel 42 collectively define an interior 52 of the tailgate 24. As shown in FIG. 3, one or more structural members 54 of the tailgate 24 may be contiguous with either the outer panel 40 or the inner panel 42 or may be within the interior 52 of the tailgate 24. The structural members 54 may provide rigidity and load bearing capability for the tailgate 24, and may provide a structure to fasten accessories of the vehicle 10 into. In FIG. 3, one structural member 54 is configured as an X-shaped metal brace 56, and two vertically spaced apart cross members 58 are provided.

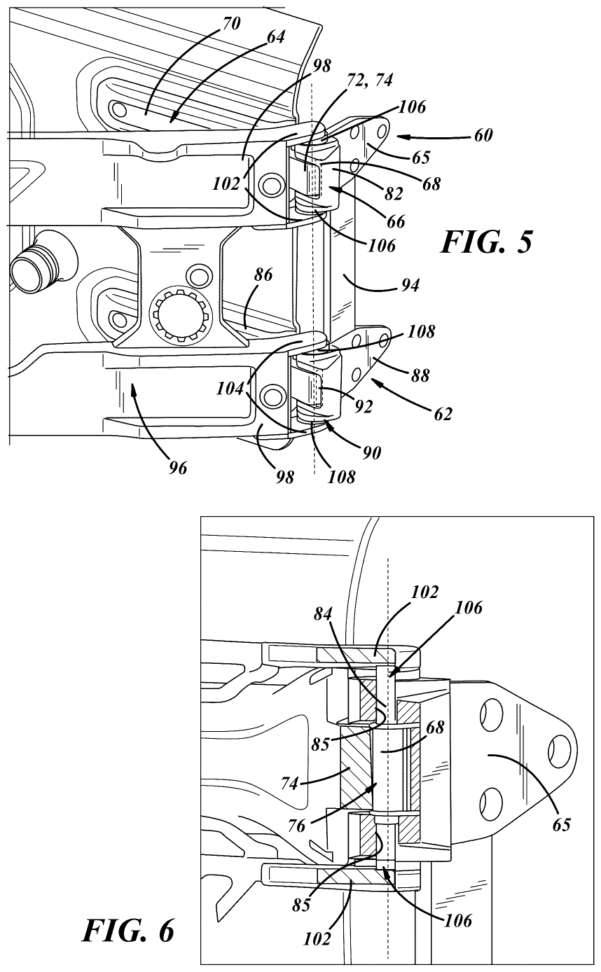

As shown by FIGS. 2, 4 and 5, the hinge assembly 34 pivotably connects the tailgate 24 to the structure of the vehicle 10 at the first end 32 of the tailgate 24. The hinge assembly 34 includes a first hinge 60 and a second hinge 62. Referring to FIG. 5, the first hinge 60 has a first door leaf 64, a first mount leaf 65, a first knuckle 66 defined in part by both leafs 64, 65, and a first hinge pin 68. The first door leaf 64 is adapted to be connected at a first end 70 to the tailgate 24. In some implementations, the first door leaf 64 may be positioned on the outer surface 44 of the outer panel 40. The first door leaf 64 may be fastened to the tailgate 24 with fasteners or other means of coupling. Fasteners may extend through the first door leaf 64 and the outer panel 40 into one or more of the structural members 54 of the tailgate 24. However, in other implementations, the first door leaf 64 may be configured to couple with the tailgate 24 at other portions of the tailgate 24, such as the inner surface 46 of the outer panel 40, directly to the structural members 54, the inner surface 50 of the inner panel 42, or the outer surface 48 of the inner panel 42. The first door leaf 64 extends from the first end 70 to a free end 72. The free end 72 may be defined by one or more projections that defines part of the first knuckle 66. In the example shown, the first door leaf 64 includes a single projection 74, and the projection 74 has a passage 76 (FIG. 6) formed therethrough to receive part of the first hinge pin 68.

The first mount leaf 65 is adapted to be connected to the structure of the vehicle 10 such as by fasteners or by other means of coupling. When the first mount leaf 65 is installed on the vehicle 10, a free end 82 of the first mount leaf 65 extends towards the first end 32 of the tailgate 24 to couple with other components of the hinge assembly 34. In more detail, the first mount leaf 65 includes one or more projections 83, shown as a pair of vertically spaced apart projections 83, that each define part of the first knuckle 66. Each of these projections 83 has a passage 85 (FIG. 6) formed therein and arranged to receive part of the first hinge pin 68.

As set forth above, the first knuckle 66 (FIG. 4) is defined partly by both the first door leaf 64 and the first mount leaf 65. In assembly, the projection(s) 74 of the first door leaf 64 are interleaved with the projection(s) 83 of the first mount leaf 65 and the passages 76, 85 in each projection 74, 83 align to define a first hinge passage 84 in which the first hinge pin 68 is received to pivotably couple together the first door leaf 64 and the first mount leaf 65. The first hinge passage 84 and the first hinge pin 68 (FIG. 6) collectively define an axis of rotation 69 (FIG. 2) of the first door leaf 64 relative to the first mount leaf 65, and hence, the axis of rotation 69 of the tailgate 24 relative to the vehicle structure. At the first knuckle 66, a portion of the free end 82 of the first mount leaf 65 is configured at least partially axially overlap the first door leaf 64 at the first knuckle 66 relative to the axis of rotation 69 (FIGS. 4-5). The first mount leaf 65 may also at least partially radially and circumferentially overlap the first door leaf 64 at the first knuckle 66 relative to the axis of rotation.

The second hinge 62 is positioned coaxially with the first hinge 60, axially spaced from the first hinge 60, and may be constructed identically to the first hinge 60, in at least some implementations. Because they may be constructed identically, the second hinge 62 will not be described in detail and descriptions of the first hinge 60 and its respective components may be applied to the second hinge 62 unless stated otherwise. The second hinge 62 includes a second door leaf 86 connected to the tailgate 24, a second mount leaf 88 adapted to be connected to the vehicle structure, a second knuckle 90 defined in part by both the second door leaf 86 and the second mount leaf 88, and a second hinge pin 92 (FIG. 5).

In some implementations, as shown in FIGS. 2, 4 and 5, the first mount leaf 65 and the second mount leaf 88 may be connected by a cross member 94 that spans vertically between the first mount leaf 65 and the second mount leaf 88. The cross member 94 may be rigid, formed of metal, and provided to reinforce the hinge assembly 34 and improve stability of the hinge assembly 34, to ensure the first hinge 60 and second hinge 62 remain coaxially aligned, and to better accommodate the weight of the tailgate 24 and any accessories.

As shown by FIGS. 2 and 5, a bracket 96 is coupled at a first end 98 to the hinge assembly 34. The bracket 96, in the implementations shown, has an arm 100 that has two pairs of spaced apart fingers 102, 104. Each pair of fingers 102, 104 is axially spaced apart relative to the axis of rotation 69 of the tailgate 24, and the fingers 102, 104 may extend at least partially beyond the first end 32 of the tailgate 24. A first pair of fingers 102 axially overlaps the first knuckle 66 and a second pair of fingers 104 axially overlaps the second knuckle 90. One finger of the first pair 102 is received on a first side of the first knuckle 66 and another finger of the first pair 102 is received on a second side of the first knuckle 66.

With reference to FIGS. 5 and 6, one finger of the second pair 104 is received on a first side of the second knuckle 90 and another finger of the second pair 104 is received on a second side of the second knuckle 90. Each finger of the first pair 102 includes an opening or passage that defines part of a first bracket passage 106 in which the first hinge pin 68 is received. Each finger of the second pair 104 also includes an opening or passage that defines part of a second bracket passage 108 in which the second hinge pin 92 is received. In this way, the bracket 96 is coupled to the first hinge 60 and the second hinge 62 by the hinge pins 68, 92. In the implementation shown, the fingers are arranged outboard of the knuckles 66, 90 of the first and second hinges 60, 62, but the fingers may be otherwise arranged, including having one or more fingers interleaved with the projections of the hinges 60, 62. So arranged, the bracket 96 and the tailgate 24 share the same axis of rotation about the first hinge pin 68 and the second hinge pin 92.

As shown in FIG. 2, the arm 100 of the bracket 96 extends along the outer surface 44 of the outer panel 40 from the first end 32 of the tailgate 24 towards the free end 36 of the tailgate 24. The bracket 96 may be coupled to the tailgate 24 by fasteners 109 or by other means of coupling. In the implementation shown by FIG. 2, the bracket 96 may be fastened to the tailgate 24 so that the bracket 96 may move with the tailgate 24 as the tailgate 24 is rotated/moved about the axis of rotation.

A wheel mount 110, shown in FIGS. 1 and 7, may be defined at least partially by or coupled to the bracket 96, so that the wheel mount 110 is fixed to the bracket 96 in each of the fore-aft, cross-car, and vertical directions. The wheel mount 110 is configured to carry a spare wheel assembly 112 (e.g. a tire and wheel hub/rim) for the vehicle and wheel assembly 112 may be connected to the wheel mount 110 using lug nuts or lug bolts, like how the wheel 112 would be connected to a hub mount of the vehicle 10.

The hinge assembly 34 permits the tailgate 24 to be rotatable about the axis of rotation to and between an open position (FIG. 7) and a closed position (FIG. 1), wherein in the open position the tailgate 24 and the bracket 96 can be rotated about the axis of rotation 69 and in the closed position, rotation of the tailgate 24 and the bracket 96 may be prevented by the latch and latch mechanism 38 that may secure the tailgate 24 to the frame or body 14.

One or more gaskets or dampers 113 may be positioned between the bracket 96 and the outer panel 40, the structure of the vehicle 10 and the first mount leaf 65 and second mount leaf 88, or the first door leaf 64, the second door leaf 86 and the tailgate 24. The one or more gaskets 113 may be made of a polymeric, elastomeric, or other material useful for reducing vibrations between the structure of the vehicle 10, the hinge assembly 34, and the tailgate 24.

By mounting the bracket 96 to the hinge assembly 34 separately from the tailgate 24, the weight of the wheel mount 110 and the spare wheel assembly 112 can be transferred directly to the vehicle support structure (e.g. member 35) through the bracket 96 and hinge assembly 34. This reduces the load on the tailgate 24 from the bracket 96 and the spare wheel 112, and thus, the load requirements of the tailgate 24 may be reduced. This allows for a lighter-duty tailgate 24 design with reduced thickness, lower profile, and/or with a lighter-duty structural members.

Additionally, without the weight of the spare wheel 112 on the tailgate 24, the tailgate 24 may accommodate additional accessories or larger accessories without increasing the profile or structure of the tailgate 24, which may otherwise reduce the size of or impede the interior 52 of the tailgate 24. For example, a rear window 114 (FIG. 1) may be carried by the tailgate 24, and may be configured to be retractable and stored at least partially within the interior 52 of the tailgate 24 (FIG. 8). The rear window may include an actuator assembly 111 to move the position of the window within and out of the interior. Furthermore, a larger, heavier spare wheel 112, that may exceed the load capacity of the tailgate 24 itself, may be mounted to the bracket 96 without increasing the load requirements of the tailgate 24. This may be useful for users who desire modifying his or her vehicle 10 with larger or heavier wheels or tires, which may be advantageous for off-road use of the vehicle 10. If a vehicle 10 with larger wheels and/or tires experiences a flat tire, having a full-sized spare, that is a larger or heavier tire that matches the four tires on the road, permits replacement of the flat tire with a correctly sized spare tire so that the vehicle can safely continue traveling. Without the bracket 96, a larger or heavier spare tire may deform the tailgate 24, impede moving the tailgate 24 between its open and closed positions, may prevent movement of the window 114, or may damage the window 114 or other accessory of the tailgate 24.

Because the tailgate 24, the bracket 96, the first hinge 60 and the second hinge 62 share a common axis of rotation, the bracket 96 and tailgate 24 can be supported directly by the hinge assembly 34 and the structure of the vehicle 10, and the bracket 96 and tailgate 24 can move together as the tailgate 24 is opened and closed. If the bracket 96 had a separate axis of rotation from the tailgate 24, creating a movement commonly known in the art as a four-bar linkage movement, the bracket 96 would be unable to open along the same path of the tailgate 24. This would require that the bracket 96 be moved relative to and away from the tailgate 24 before the tailgate 24 is opened. This creates additional, inconvenient, and undesirable steps for the user of the vehicle 10 to operate the tailgate 24. Further, a tailgate 24 with a four-bar linkage type movement may require a second latch and a second latch mechanism separate from the tailgate 24 to couple the bracket 96 to the tailgate 24.

In at least some implementations, the mount leafs 65, 88 for both first and second hinges 60, 62 are coupled to the vehicle structure with the first ends located behind a body panel so that the first ends are not visible from outside the vehicle 10. The cross-member 94 is also adjacent to the support structure, located behind the body panel(s) and not visible outside the vehicle 10. The knuckles 66, 90 are exposed/located outboard of the body panels to facilitate connection of the bracket 96 and tailgate 24 to the hinge assembly 34. In this implementation, the rear of the vehicle 10 may have a cleaner, or more aesthetically pleasing appearance while retaining functionality of the tailgate 24.

What is claimed is:

1. A mount for a tailgate and a wheel, comprising:
a first hinge having a first door leaf adapted to be connected to a vehicle tailgate, a first mount leaf adapted to be connected to a vehicle, a first knuckle defined by both the first door leaf and the first mount leaf, and a first hinge pin, wherein the first knuckle includes a first hinge passage and the first hinge pin is received in the first hinge passage, the first hinge pin defines an axis of rotation of the first door leaf relative to the first mount leaf;
a second hinge spaced from the first hinge, the second hinge having a second door leaf adapted to be connected to the same vehicle tailgate as the first door leaf, a second mount leaf adapted to be connected to the vehicle, a second knuckle defined in part by both the second door leaf and the second mount leaf, and a second hinge pin, wherein the second knuckle includes a second hinge passage and the second hinge pin is received in the second hinge passage, the second hinge pin defines an axis of rotation of the second door leaf relative to the second mount leaf, and the second hinge pin is coaxial with the first hinge pin and axially spaced from the first hinge pin; and
a bracket that has an arm, wherein the arm has a first pair of spaced apart fingers and a second pair of spaced apart fingers extending from the arm, the arm defines at least part of a tire mount adapted to receive a tire, and the first pair of spaced apart fingers define part of a first bracket passage in which the first hinge pin is received and the second pair of spaced apart fingers define part of a second bracket passage in which the second hinge pin is received so that the bracket is connected to the first hinge and the second hinge, and the first hinge pin and the second hinge pin define an axis of rotation of the bracket.

2. The mount of claim 1, wherein the first mount leaf and the second mount leaf are connected by a cross-member.

3. The mount of claim 1, wherein the first mount leaf at least partially axially overlaps the first door leaf at the first knuckle, relative to the axis of rotation.

4. The mount of claim 3, wherein the second mount leaf at least partially axially overlaps the second door leaf at the second knuckle, relative to the axis of rotation.

5. The mount of claim 1, wherein the first mount leaf at least partially radially overlaps the first door leaf at the first knuckle relative to the axis of rotation.

6. The mount of claim 5, wherein the second mount leaf at least partially radially overlaps the second door leaf at the second knuckle relative to the axis of rotation.

7. A vehicle comprising:
a frame;
a tailgate;
a first hinge having a first door leaf connected to the tailgate, a first mount leaf connected to the frame, a first knuckle defined in part by both the first door leaf and the first mount leaf, and a first hinge pin, wherein the first knuckle includes a first hinge passage and the first hinge pin is received in the first hinge passage, the first hinge pin defines an axis of rotation of the first door leaf relative to the first mount leaf;
a second hinge spaced from the first hinge, the second hinge having a second door leaf connected to the tailgate, a second mount leaf connected to the frame, a second knuckle defined in part by both the second door leaf and the second mount leaf, and a second hinge pin, wherein the second knuckle includes a second hinge passage and the second hinge pin is received in the second hinge passage, the second hinge pin defines an axis of rotation of the second door leaf relative to the second mount leaf, and the second hinge pin is axially aligned with the first hinge pin and axially spaced from the first hinge pin; and
a bracket that has an arm, wherein the arm has a first pair of spaced apart fingers and a second pair of spaced apart fingers extending from the arm, the arm defines at least part of a tire mount adapted to receive a tire, and the first pair of spaced apart fingers define part of a first bracket passage in which the first hinge pin is received and the second pair of spaced apart fingers define part of a second bracket passage in which the second hinge pin is received so that the bracket is connected to the first hinge and the second hinge, and the first hinge pin and the second hinge pin define an axis of rotation of the bracket.

8. The vehicle of claim 7, wherein the tailgate has an inner panel and an outer panel, the inner panel and the outer panel each have inner surfaces that define an interior of the tailgate, and the inner panel and the outer panel each have outer surfaces that define an exterior of the tailgate, and the first door leaf and the second door leaf are located on the exterior of the tailgate.

9. The vehicle of claim 8, wherein the first door leaf and the second door leaf are coupled to the support structure of the tailgate.

10. The vehicle of claim 7, wherein the tailgate has an inner panel and an outer panel, the inner panel and the outer panel each have inner surfaces that define an interior of the tailgate and the inner panel and the outer panel each have outer surfaces that define an exterior of the tailgate, and the first door leaf and the second door leaf are coupled to the tailgate and a structural member within the interior of the tailgate.

11. The vehicle of claim 8, wherein the bracket is fixed to the outer panel so that the bracket and the tailgate move together about the axis of rotation.

12. The vehicle of claim 8, further comprising a structural member within the interior of the tailgate, wherein the first door leaf and the second door leaf are coupled to the structural member.

13. The vehicle of claim 12, wherein the structural member is contiguous with the inner surface of the outer panel.

14. The vehicle of claim 8, wherein the interior of the tailgate is configured to at least partially enclose a window between the inner surfaces of the inner panel and the outer panel and an actuator assembly configured to move the position of the window within and out of the interior.

15. The vehicle of claim 7, wherein the bracket supports the wheel mount and a wheel of the vehicle.

16. The vehicle of claim 7, wherein a first pair of the two pairs of fingers are received axially outboard of the first knuckle.

17. The vehicle of claim 16 wherein one finger of the first pair is received on a first side of the first knuckle and another finger of the first pair is received on a second side of the first knuckle.

18. The vehicle of claim 16 wherein a second pair of the two pairs of fingers are received axially outboard of the second knuckle.
